(19) United States
(12) Patent Application Publication
(10) Pub. No.: US 2015/0262122 A1
(43) Pub. Date: Sep. 17, 2015

(54) SYSTEM AND METHOD FOR ELECTRONIC RECEIPT OF POSTAL MAIL

(71) Applicant: Willie S. Jenkins, Albany, GA (US)

(72) Inventor: Willie S. Jenkins, Albany, GA (US)

(21) Appl. No.: 14/644,145

(22) Filed: Mar. 10, 2015

Related U.S. Application Data
(60) Provisional application No. 61/952,041, filed on Mar. 12, 2014.

(51) Int. Cl. G06Q 10/08; G06Q 50/32

(52) U.S. Cl. CPC G06Q 10/0833; G06Q 50/32

(57) ABSTRACT

A system and method for providing electronic notification to a user concerning the delivery of postal mail. The system and method for electronic notification employs a transmitting station which is deployed by a user in the receptacle in which the user receives postal mail and a computer device that provides the primary user interface for the system and method for electronic notification. The transmitting station is oriented in the postal mail receptacle so that when postal mail is inserted therein, an integrated notification lever is moved from its resting position to a second position. When the notification lever is moved from its resting position a notification of mail signal is generated and transmitted to the computer device. Upon receipt of the notification of mail signal, the computer device displays a mail delivered message on its display and provides an interface to view such messages.

### CROSS REFERENCE TO RELATED APPLICATIONS

This application claims the benefit of and incorporates by reference co-pending U.S. provisional patent application Ser. No. 61/952,041 filed Mar. 12, 2014.

### BACKGROUND OF THE INVENTION

1. Field of the Invention

This invention relates generally to mobile computer applications and, more particularly, to a system and method implemented through a mobile computer for electronic notification of postal mail receipt.

2. Description of the Prior Art

Sending and receiving postal mail (including any documents and packages distributed through physically delivered) through existing postal services and delivery services is well known. A problem which still exists, however, recipients of postal mail, and other mail which is physically delivered, generally must be physically present at their mail receiving receptacle in order to known whether they have received anything on a given day. Thus, there remains a need for a system and method for electronically notifying a user of the receipt of postal mail in real time. It would be helpful if such a system and method for electronic notification was embodied in an application for a mobile computer. It would be additionally desirable for such a system and method for electronic notification to be able to be employed to notify senders of postal mail of the delivery of the same.

The Applicant's invention described herein provides for a system and method for electronic notification adapted to notify a user when postal mail has been delivered. The primary components in Applicant's system and method for electronic notification are a computer device configured through a software application to perform the steps of the method and a transmitting station. When in operation, the system and method for electronic notification enables effective and efficient tracking of transporting of postal mail. As a result, many of the limitations imposed by prior art structures are removed.

### SUMMARY OF THE INVENTION

A system and method for providing electronic notification to a user concerning the delivery of postal mail. The system and method for electronic notification employs a transmitting station which is deployed by a user in the receptacle in which the user receives postal mail and a computer device that provides the primary user interface for the system and method for electronic notification. The transmitting station is oriented in the postal mail receptacle so that when postal mail is inserted therein, an integrated notification lever is moved from its resting position to a second position. When the notification lever is moved from its resting position a notification of mail signal is generated and transmitted to the computer device. Upon receipt of the notification of mail signal, the computer device displays a mail delivered message on its display and provides an interface to view such messages (as well as when they were received).

It is an object of this invention to provide a system and method for electronically notifying a user of the receipt of postal mail in real time.

It is another object of this invention to provide a system and method for electronic notification embodied in an application for a mobile computer.

It is yet another object of this invention to provide a system and method for electronic notification that was able to be employed to notify senders of postal mail of the delivery of the same.

These and other objects will be apparent to one of skill in the art.

### BRIEF DESCRIPTION OF THE DRAWINGS

FIG. 1 is a front view of a computer device configured to employ the system and method for electronic notification in accordance with the present invention.

FIG. 2 is a side view of a computer device configured to employ the system and method for electronic notification in accordance with the present invention.

FIG. 3 is a front view of a transmitting station built in accordance with the present invention.

FIG. 4 shows the process in which a computer device application performs the method for electronic notification in accordance with the present invention.

### DETAILED DESCRIPTION OF THE INVENTION

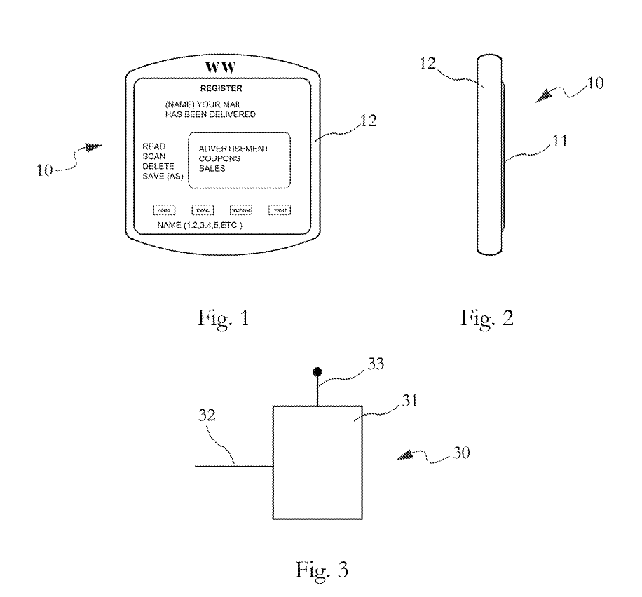

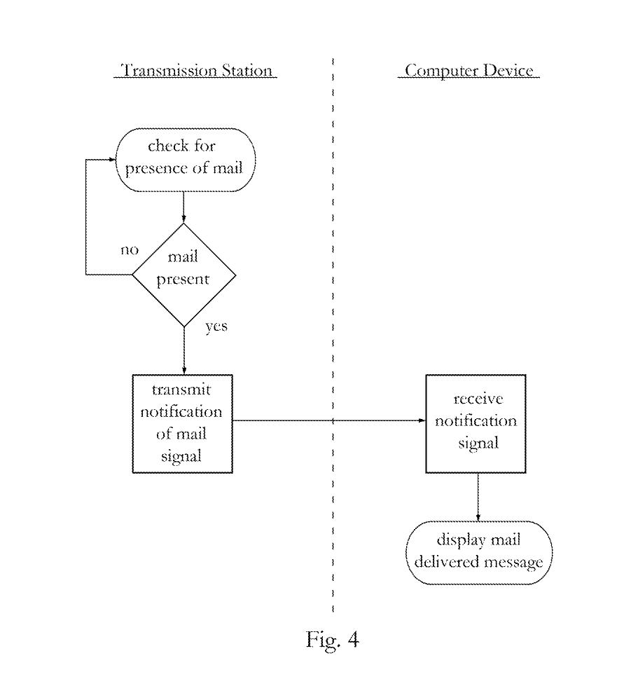

Referring now to the drawings and in particular FIGS. 1 and 2, a computer device 10 configured to employ the system and method for electronic notification is shown as a conventional handheld electronic device having a touch screen display 11 and a rigid body member 12. The computer device 10 provides the primary user interface for the system and method for electronic notification as it includes a wireless networking protocol that allows it to receive messages concerning the presence of postal mail in a user's postal mail receptacle, view such messages on the display, and perform actions relating to such messages on the display. It is contemplated that as with conventional mobile computer devices, the computer device additionally includes a processor, non-volatile memory, a battery, an operating software component. The computer device 10 is configured to employ the system and method for electronic notification through the loading of an electronic notification software application onto its memory in a manner which enables the electronic notification software application to provide instructions to the processor for performing the method of electronic notification described in FIG. 4.

Referring now to FIG. 3, the system and method for electronic notification employs a transmitting station 30 which is deployed by a user in the receptacle in which the user receives postal mail. The transmitting station 30 includes a base housing 31, a spring loaded notification lever 32 and an antenna 33. In addition, disposed inside the base housing 31 is a power source and transceiver.

Referring now to FIGS. 1-4, in operation, the transmitting station 30 is oriented in the postal mail receptacle so that when postal mail is inserted therein, the notification lever 32 is moved from its resting position to a second position. The spring loaded feature enables the notification lever 32 to be held in the second position as long as postal mail remains in the receptacle. When the notification lever 32 is moved from its resting position, a signal is sent to the transceiver. The transceiver then transmits a notification of mail signal through the antenna 33 to the computer device 10. In the preferred embodiment, this notification of mail signal is sent over a wireless networking protocol. Once the computer device 10 receives the signal, it displays a mail delivered message on its display and if desired, provides an audible, visual, or tactile alert. On the display, a user can view messages, such as the mail delivered message, delete messages, or review older messages.

In an alternate embodiment, the method of notification of mail may additionally enable a user to register their name into a cloud based, centralized mailing system read the contents of their mail on the computer device. In such an embodiment, the centralized mailing system would have incoming mail scanned and uploaded to a cloud server so that it would be accessible over a computer networking protocol, such as the Internet. In accordance with the same, if the sender of postal mail was also registered with the centralized mailing system, they could be notified of the delivery of the same on the computer device.

In an alternate embodiment, the computer device can be used to download and play various software applications such as games, crossword puzzles, board games, books, dictionaries, and thesauruses.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for providing electronic notification to a user concerning the delivery of postal mail for a driving tool, comprising the steps of:
providing a transmitting station deployed in a receptacle in which the user receives postal mail, wherein said transmitting station is configured to recognize the placement of items in the receptacle and transmit an electronic message upon recognizing the placement of items in the receptacle;
providing a computer device configured to receive electronic messages from said transmitting station and display information relating to received electronic messages;
transmitting by said transmitting station an electronic message defining a notification of mail signal to said computer device upon recognizing the placement of items in the receptacle; and
displaying by said computer device information related to the notification of mail signal received.

2. The method of claim 1, wherein the transmitting station is configured to transmit the electronic message wirelessly upon the placement of items in the receptacle through the inclusion of a notification lever, an antenna, and a power source, with the transmitting station is oriented in the receptacle such that as items are placed into the receptacle the notification lever is moved from a resting position to a second position.

3. The method of claim 2, wherein the transmitting station is configured to recognize the placement of items in the receptacle by said notification lever being moved to a second position.

4. The method of claim 3, said notification lever is biased such that it remains in the resting position unless it is deflected by items being placed into the receptacle.

5. The method of claim 1, wherein said electronic messages are transmitted and received wirelessly.

6. The method of claim 5, wherein the computer device is configured to receive electronic messages from said transmitting station and display information relating to receipted electronic messages through the inclusion of a touch screen display and a wireless networking protocol.
